(19) United States
(12) Patent Application Publication
(10) Pub. No.: US 2026/0316656 A1
(43) Pub. Date: Oct. 15, 2026

(54) ANIMAL TRANSPORT TRAILER

(71) Applicant: Michael Cullinan, Ennis (IE)

(72) Inventor: Michael Cullinan, Ennis (IE)

(21) Appl. No.: 19/465,437

(22) Filed: Jan. 30, 2026

(30) Foreign Application Priority Data
Aug. 2, 2023 (IE) 2023/0309

(51) Int. Cl. B60P 1/43; B60P 3/04

(52) U.S. Cl. CPC B60P 1/435; B60P 3/04

(57) ABSTRACT

An animal transport trailer (10) comprises a pivotally attached ramp (20) at one end of the trailer for loading and unloading animals and at two gates (30) for closing the said end of the trailer. The gates are pneumatically or hydraulically operable by a pneumatic or hydraulic cylinder (32) which is remotely operated by user standing remote from the trailer. A side wing (24) is mounted at each side of the ramp (20) so that when the ramp is in an open position, each of the gates (30) interact with a corresponding side wing (24) to form a complete barrier at the sides of the ramp. The remote operation is performed by a control apparatus connected by a cable to the operating mechanism or by a radio wave remote unit. The gates can be provided with a spring and ratchet mechanism to assist in their opening.

### CROSS-REFERENCE TO RELATED APPLICATIONS

This application is a national filing based on International Application No: PCT/EP2024/072033 filed Aug. 2, 2024, which claims the benefit of priority to Ireland (IE) patent application 2023/0309 filed Aug. 2, 2023. The entire disclosure of each of the applications listed in this paragraph are incorporated herein by specific reference thereto.

### FIELD OF INVENTION

The present invention relates to an improved animal transport trailer, device, system and method. In particular, it relates to a trailer for transporting farm animals. In particular, it relates to a trailer for cattle, each of which may be large enough to knock over a person herding them if they get excited. This can lead to serious injuries or fatal consequences for the person.

### BACKGROUND OF THE INVENTION

Traditionally such trailers have a loading/unloading ramp and one or two gates to keep the animals in the trailer after the ramp has been opened. These gates must be opened by the user and sometimes the cattle can rush the gates before the person can get out of the way. Likewise, when the user is trying to load cattle in the trailer, it can be a dangerous operation, particularly when trying to close the gates on the cattle.

### SUMMARY OF THE INVENTION

It is an object of the invention to provide an animal transport trailer which alleviates the disadvantages associated with prior art trailers.

The present invention provides an animal transport trailer of a generally rectangular shaped construction having at least four sides, namely a floor, two parallel walls and a roof or cover, the trailer comprising a pivotally attached ramp fixed to the floor at one end of the trailer for loading and unloading animals, at least one gate for closing the said end of the trailer, characterised in that the gate is pneumatically or hydraulically operable by a pneumatic or hydraulic cylinder and wherein the cylinder is remotely operated by a user remote from the trailer.

Advantageously, two gates are provided for closing said end of the trailer, each gate being pivotally mounted at opposite sides of the trailer and having a pneumatic or hydraulic cylinder for separately opening and closing each gate to overlap one another, each gate being operable remotely.

Conveniently, a side wing is mounted at each side of the ramp so that when the ramp is in an open position, each of the gates interacts with a corresponding side wing to form a complete barrier at the sides of the ramp.

Ideally, the remote operation is performed by a control apparatus connected by cable to the operating mechanism.

Alternatively, the remote operation is performed by a radio wave remote unit.

Preferably each gate is provided with a spring mechanism adjacent its hinge to assist with the opening and closing of the gate.

Ideally, each gate is provided with a ratchet means which keeps the gate in an open position until released.

Optionally, the side ramps are fixed at right angles to the ramp and overlie the side walls of the trailer when the ramp is in a closed position.

Conveniently, the side ramps are fixed to the ramp by brackets in a manner not to hit or obstruct any lights fitted to the trailer.

Advantageously, the brackets are adjustable in length so as to be attachable to different sized trailers.

Alternatelively, the side wings are attached by hinges to the ramp and are movable into position generally at right angles to the ramp for use and are movable into a stowed position by folding against the closed ramp for transport.

Preferably, the two gates are locked together by a latching mechanism.

Optionally the latching mechanism comprises an engageable spring loaded mechanical latch mounted on the two gates.

Alternatively, the latching mechanism is an electromagnetic lock which comprises a receiver fixed to one gate and an electromagnet fixed to the other gate.

As a further alternative the latching mechanism comprises said mechanical latch and said electromagnetic.

Further objects and advantages of this invention will be apparent from the following detailed description of the presently preferred embodiments which are illustrated schematically in the accompanying drawings.

The invention will hereinafter be more particularly described with reference to the accompanying drawings, which show by way of example only, two embodiments of an animal transport trailer fitted with securing gates according to the invention.

### BRIEF DESCRIPTION OF DRAWINGS

The drawing figures depict one or more implementations in accord with the present concepts, by way of example only, not by way of limitations. In the figures, like reference numerals refer to the same or similar elements.

In the drawings:

FIG. 1 is an end view a first embodiment of the transport trailer with its loading ramp in an open position and the two securing gates in a closed position;

FIG. 2 is a side view of the transport trailer with its loading ramp in an open position and the securing gates in an open position;

FIG. 3 is a side view of the transport trailer with the ramp shown in a fully closed position;

FIG. 4 is an end view of the transport trailer with the ramp in a fully closed position;

FIG. 5 is a side view of the locking system which locks the two securing gates together, the locking system being unlocked;

FIG. 6 is a side view with the locking system being in a locked position.

FIG. 7 is an end view of a second embodiment transport trailer with its loading ramp in an open position and the two securing gates in a closed position;

FIG. 8 is an end view of the second embodiment of the transport trailer with its loading ramp in an open position and the securing gates in an open position and with side panels in a folded position;

FIG. 9 is an end view of the second embodiment of the transport trailer with the ramp in a fully closed position;

FIG. 10 is a side view of the transport trailer with the ramp and securing gates shown in an open position;

FIG. 11 is a side view of a first alternative locking system which locks the two securing gates together, the locking system being unlocked;

FIG. 12 is a side view of the first alternative locking system in a locked position;

FIG. 13 is a side view of a second alternative locking system which locks the two securing gates together, the locking system being unlocked; and

FIG. 14 is a side view of the second alternative locking system in a locked position.

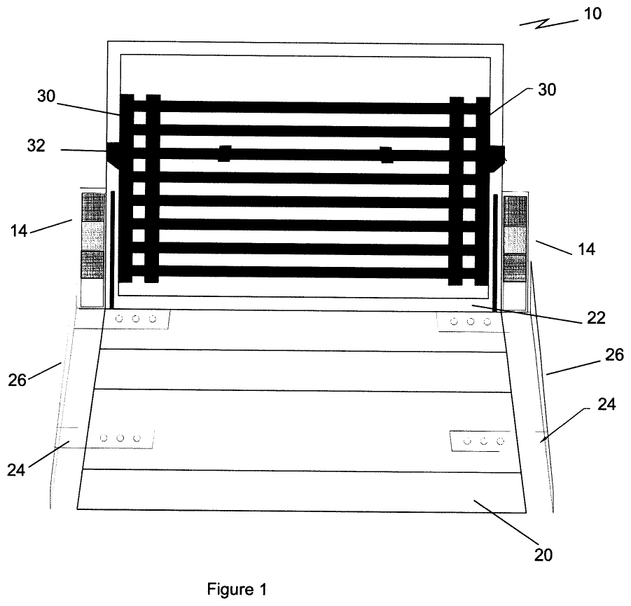

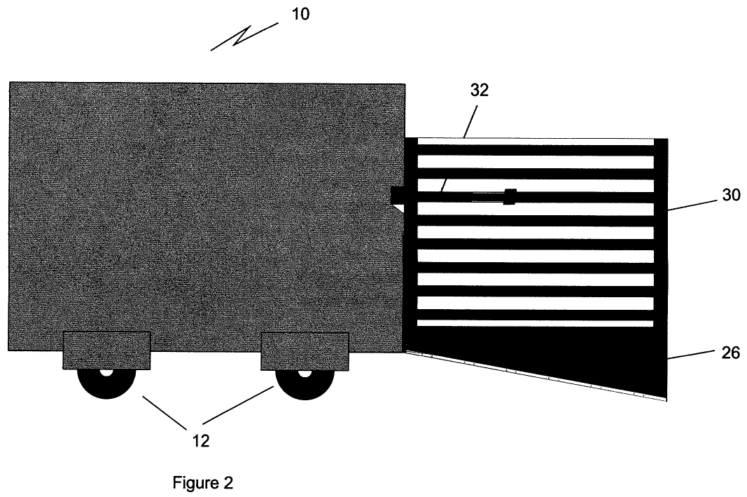

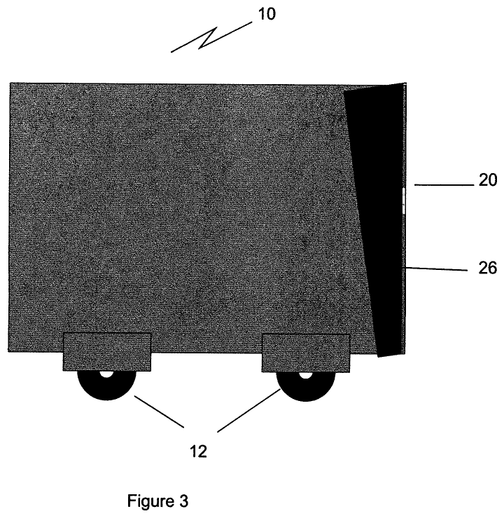

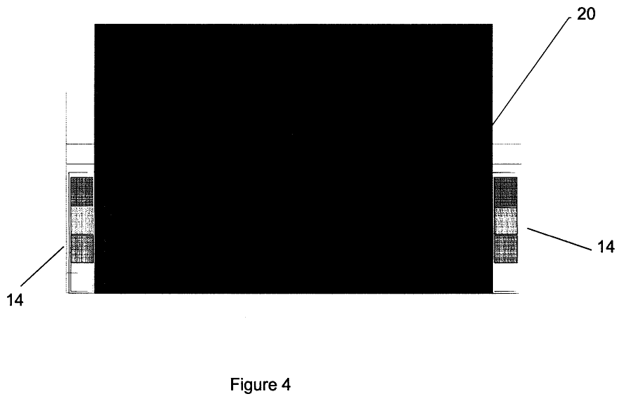

### DETAILED DESCRIPTION OF INVENTION

Before explaining the disclosed embodiments of the present invention in detail it is to be understood that the invention is not limited in its applications to the details of the particular arrangements shown since the invention is capable of other embodiments. Also, the terminology used herein is for the purpose of description and not of limitation.

In the Summary above and in the Detailed Description of Preferred Embodiments and in the accompanying drawings, reference is made to particular features (including method steps) of the invention. It is to be understood that the disclosure of the invention in this specification does not include all possible combinations of such particular features. For example, where a particular feature is disclosed in the context of a particular aspect or embodiment of the invention, that feature can also be used, to the extent possible, in combination with and/or in the context of other particular aspects and embodiments of the invention, and in the invention generally.

In this section, some embodiments of the invention will be described more fully with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will convey the scope of the invention to those skilled in the art. Like numbers refer to like elements throughout, and prime notation is used to indicate similar elements in alternative embodiments.

Other technical advantages may become readily apparent to one of ordinary skill in the art after review of the following figures and description.

It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise specifically noted, articles depicted in the drawings are not necessarily drawn to scale.

Referring to the drawings, animal transport trailer 10 is generally of rectangular shape and has two wheels 12 on each side on separate axles (not shown). Also not shown is a tow hitch by means of which the transport trailer 10 is towed by a jeep or some other suitable vehicle. The trailer 10 has four sides, a floor 12, two parallel walls 13 and a roof or cover 15 which can be flat, curved or any suitable shape.

A loading and unloading ramp 20 is provided at the rear of the transport trailer 10 pivotally attached to the lower edge of the floor 12 at the opening 22 to the trailer 10. Fitted to the sides of the ramp by means of elongate brackets 24 are a pair of wings 26 manufactured from aluminium or any suitable material and which are generally triangular in shape. When the ramp is open, the wings 26 act as side barriers and when the ramp is closed the wings 26 fit snugly at the sides of the trailer at the outside of the rear tail lights 14. The elongate brackets 24 allow sufficient clearance to not hit the tail lights 14. The ramp 20 can be manufactured from wood or suitable metallic material such as aluminium.

Two gates 30 are mounted to the walls 13 at each side of the opening to the trailer and can pivot outwardly from the walls 13 to the side of the ramp to form with the wings 26 a complete barrier for cattle or other animals which are loading or unloading from the transport trailer. The brackets 24 can be adjustable in length so as to be adjustable to fit different sized trailers.

The gates 30 are opened and closed with pneumatically powered cylinders 32 which are operated by the user using a remote control device (not shown). By virtue of the user standing away from the trailer ensures that the user is not injured by the cattle entering or leaving the trailer which can easily occur when a user is loading or unloading cattle on their own. The remote control device can be cable connected to the opening mechanism or by radio waves using a fob with a unique code for each trailer.

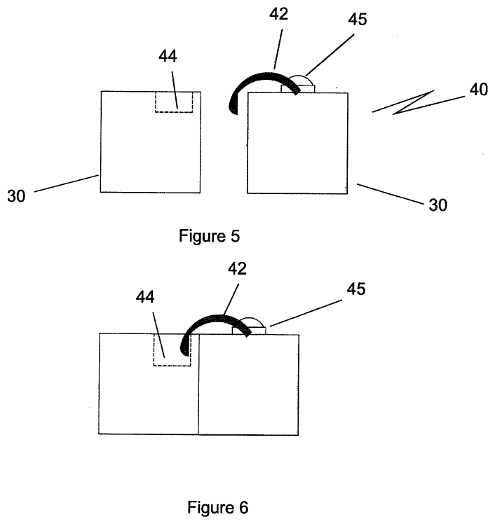

Each gate 30 is opened separately and can be closed separately. When the two gates 30 are closed, the latching mechanism 40 as shown in FIGS. 5 and 6 holds the two gates together. The spring loaded locking mechanism has a bull nosed spring 42 fixed on the orifice 44 on the second gate. The operation of the pneumatic cylinder is sufficient to release the locking mechanism 40. However, a manual release button 45 is also provided if the pneumatic operation is not sufficient to cause the release, for instance, if the gates 30 are strained or the like.

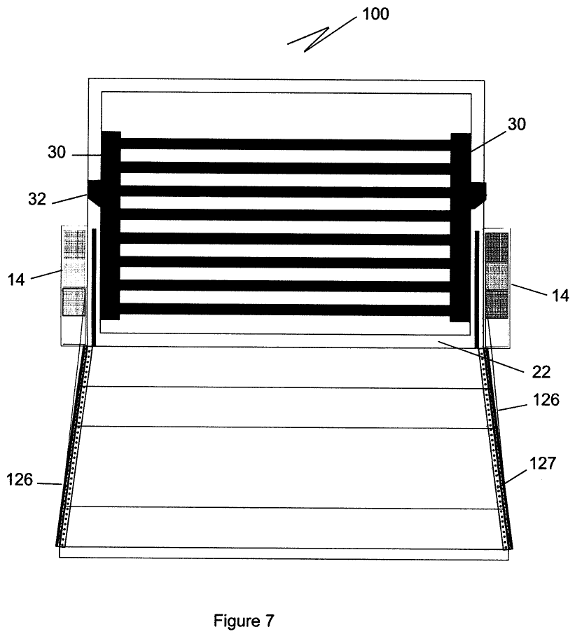

The second embodiment of trailer 100 is shown in FIGS. 7 to 10. Like parts of the first embodiment 10 are given like numerals and are not discussed again except where there are differences between the parts of the two embodiments.

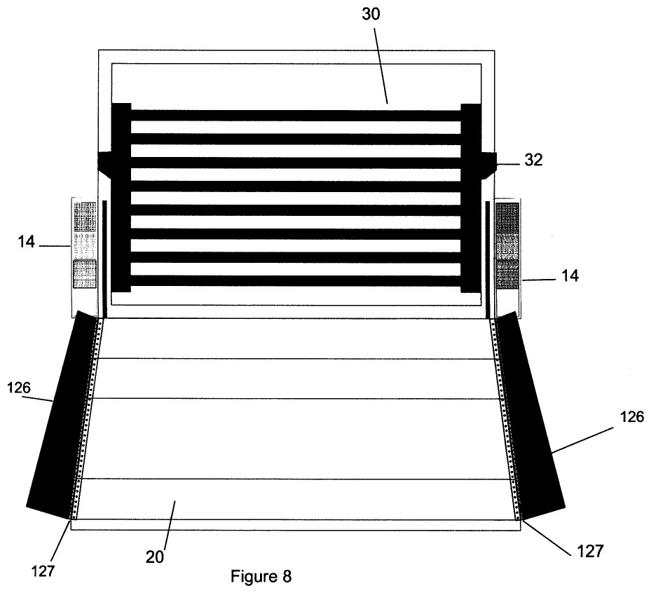

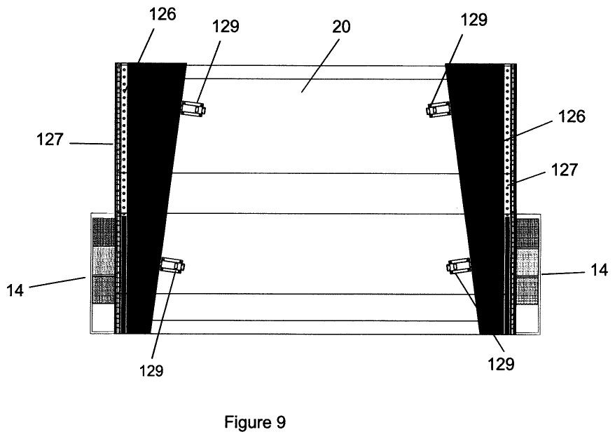

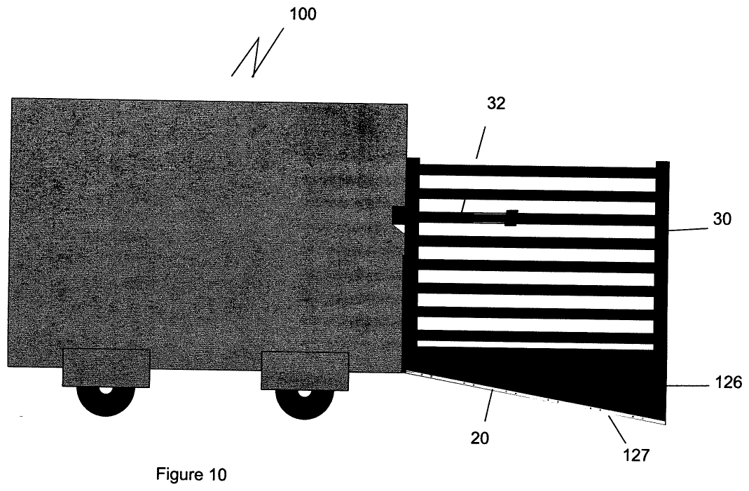

One difference between the two embodiments is that the wings 126 of the second embodiment 100 are attached by hinges 127 to the ramp 20. The wings 126 are shown in a partly folded position in FIG. 8. In FIG. 9, the wings 126 are shown in the stowed position against the closed ramp 20. The wings 126 are folded over the hinges 127 to be in contact with the ramp 20. Four deadbolts 129 secure the wings in place during transit. In FIG. 10, the ramp 20 is down, the gates 30 are open and the side ramps 126 are folded up to close off the underside of the ramp 126 below the gates.

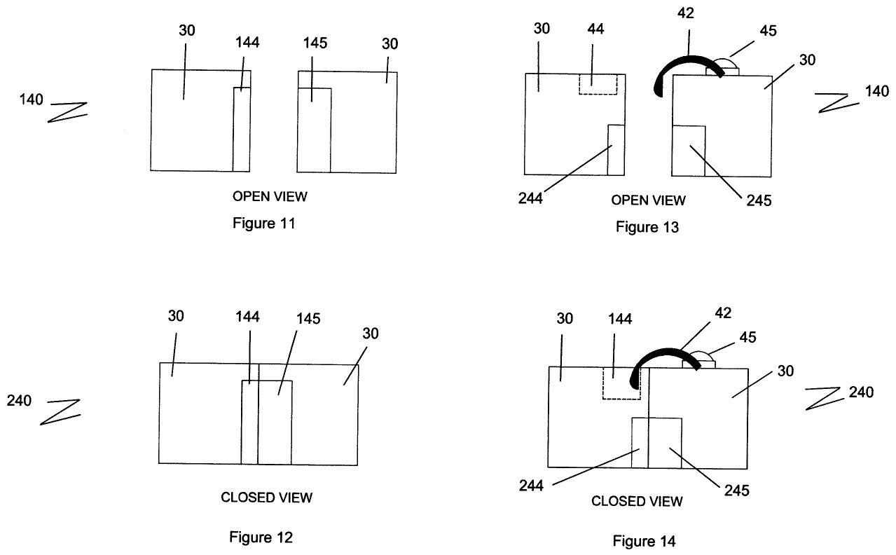

The first alternative of the locking system is shown in FIGS. 11 and 12. It comprises a latching mechanism 140 to hold the two gates 30 together. It is an electromagnetic locking system and comprises a steel plate 144 secured into one gate 30 and a fail-safe electromagnetic 145 secured into the other gate 30. It provides a heavy duty fail-safe electromagnetic locking mechanism to secure the gate 30 together with a substantial holding force. It can be disengaged using a fob or other remote control device.

The second alternative of the locking system is shown in FIGS. 13 and 14. It comprises a latching system 240 which is a combination of the latching system 40 and the latching system 140. The spring loaded bull nosed spring 42, as previously described, is used in conjunction with an electromagnetic fail safe locking mechanism. The mechanism includes a steel plate 244 screwed into one gate 30 and a fail-safe electromagnetic 245 screwed onto the other gate 30. The gates 30 may be opened using a combination of a fob, pneumatic cylinders 32 and manual hand release of the spring loaded fob 42.

The invention is a major addition to farm safety and allows one person to safely load or unload cattle or other farm animals which can easily injure a person if not moved in a controlled manner.

There are some additional modifications to the invention which are not shown in the drawings.

In an alternative embodiment, each of the gates 30 is provided with a spring and ratchet to assist in the smooth opening of both gates. A clasp is added onto both gates so that a user can grab to assist the opening of the gate if required. The springs are connected to the gates in the same manner that springs are attached to the tail gate or loading ramp of the trailer. The ratchet on each gate keeps each gate in an open position and when the ratchet is released the gate then closes again. Also, the gates 30 can lock automatically when closed for ease of operation.

These modifications will assist the opening and closing of the gates using the remote control mechanism and also function as a back up in the event that the remote control mechanism does not function for whatever reason.

Rubber stoppers are placed on the gates so as to minimize the noise of the gates closing, and thereby not frighten the cattle. There is also an automatic locking by the clasp, which is located at the ends of both wings 26 close to the trailer so that the user can simply release the lock with a finger. This is a failsafe device should the remote control mechanism malfunction.

It is to be understood that the invention is not limited to the specific details described herein which are given by way of example only and that various modifications and alterations are possible without departing from the scope of the invention as defined in the appended claims.

Although specific advantages have been enumerated above, various embodiments may include some, none, or all of the enumerated advantages.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

The term “approximately” is similar to the term “about” and can be +/−10% of the amount referenced. Additionally, preferred amounts and ranges can include the amounts and ranges referenced without the prefix of being approximately.

While the invention has been described, disclosed, illustrated and shown in various terms of certain embodiments or modifications which it has presumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

1. An animal transport trailer of a generally rectangular shaped construction having at least four sides, namely a floor, two parallel walls and a roof or cover, the trailer comprising a pivotally attached ramp fixed to the floor at one end of the trailer for loading and unloading animals, at least one gate for closing an said end of the trailer, characterised in that the gate is pneumatically or hydraulically operable by a pneumatic or hydraulic cylinder and wherein the cylinder is remotely operated by a user remote from the trailer.

2. An animal transport trailer as claimed in claim 1, in which two gates are provided for closing said end of the trailer, each gate being pivotally mounted at opposite sides of the trailer and having a pneumatic or hydraulic cylinder for separately opening and closing each gate to overlap one another, each gate being operable remotely.

3. An animal transport trailer as claimed in claim 1, in which a side wing is mounted at each side of the ramp so that when the ramp is in an open position, each of the gates interact with a corresponding side wing to form a complete barrier at the sides of the ramp.

4. An animal transport trailer as claimed in claim 1, comprising a remote control apparatus connected by a cable to an operating mechanism of the at least one gate.

5. An animal transport trailer as claimed in claim 4, in which the remote control apparatus comprises a radio wave operable remote unit.

6. An animal transport tailer as claimed in claim 1, in which each gate is provided with a spring mechanism adjacent its hinge to assist with the opening and closing of the gate.

7. An animal transport trailer as claimed in claim 6, in which each gate is provided with a ratchet means which keeps the gate in an open position until released.

8. An animal transport trailed as claimed in claim 3, which the side wings are fixed at right angles to the ramp and overlie the side walls of the trailer when the ramp is in the closed position.

9. An animal transport trailer as claimed in claim 8, in which the side wings are fixed to the ramp by brackets in a manner not to hit or obstruct any lights fitted to the trailer.

10. An animal transport trailer as claimed in claim 9, in which the brackets are adjustable in length so as to be attached to different sized trailers.

11. An animal transport trailer as claimed in claim 3, in which side wings are attached by hinges to the ramp and are movable into position generally at right angles to the ramp for use and are movable into a stowed position by folding against the closed ramp for transport.

12. An animal transport trailer as claimed in claim 2, in which the two gates are locked together by a latching mechanism.

13. An animal transport trailer as claimed in claim 12, in which the latching mechanism comprises an engageable spring loaded mechanical latch mounted on the two gates.

14. An animal transport trailer as claimed in claim 12, in which the latching mechanism is an electromagnetic lock which comprises a receiver fixed to one gate and an electromagnet fixed to the other gate.

15. An animal transport trailer as claimed in claim 12, in which the latching mechanism comprises a mechanical latch.
